(19) United States
(12) Patent Application Publication
(10) Pub. No.: US 2013/0201548 A1
(43) Pub. Date: Aug. 8, 2013

(54) ELECTRONIC INK DISPLAY DEVICE

(71) Applicant: E Ink Holdings Inc., Hsinchu (TW)

(72) Inventors: Chi-Ming Wu, Hsinchu (TW); Ian French, Hsinchu (GB)

(73) Assignee: E Ink Holdings Inc., Hsinchu (TW)

(21) Appl. No.: 13/661,323

(22) Filed: Oct. 26, 2012

Related U.S. Application Data
(60) Provisional application No. 61/595,698, filed on Feb. 7, 2012.

(30) Foreign Application Priority Data
Jul. 9, 2012 (TW) 101124647

(51) Int. Cl. G02F 1/167

(52) U.S. Cl. 359/296

(57) ABSTRACT

An electronic-ink display device includes a cover plate, an electronic-ink display, a frame, and a water-proof glue. The electronic-ink display is disposed on the cover plate. The frame is disposed on a periphery area of the cover plate and surrounds the electronic-ink display to form a circular trench. Then, the water-proof glue fills the circular trench.

### CROSS-REFERENCE TO RELATED APPLICATION

This application claims the priority benefit of U.S. Provisional Application Ser. No. 61/595,698 filed Feb. 7, 2012, and Taiwan Application Ser. Number 101124647, filed Jul. 9, 2012, the full disclosure of which is incorporated herein by reference.

### BACKGROUND

1. Technical Field

The disclosure relates to an electronic-ink display device.

2. Description of Related Art

E-paper is a display technology having advantages of paper-like, ultra-thin, lightweight, bendable, and low power consumption. The research of E-paper is mainly focused on electrophoretic display technology and cholesteric liquid crystal display technology. The most widely used technology is electrophoretic display technology. In 2009, more than 90% of E-paper adopt the electrophoretic display technology.

The display surface of the E-paper display device (or called as electronic-ink display device) is usually protected by a layer of soft plastic material. However, since the hardness of the plastic material is not enough to protect the E-paper display device, the E-paper display device could be easily damaged by surface impact. Furthermore, if tempered glass is used to protect E-paper display device, the E-paper display device will be thick and heavy.

### SUMMARY

Accordingly, in one aspect, the present invention is directed to an electronic-ink display device with better protection and lightweight.

The electronic-ink display device above includes a cover plate, an electronic-ink display, a frame, and a water-proof glue. The electronic-ink display is disposed on the cover plate. The frame is disposed on a peripheral area of the cover plate, and surrounds the electronic-ink display to form a circular trench. The water-proof glue fills the circular trench.

The foregoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later. Many of the attendant features will be more readily appreciated as the same becomes better understood by reference to the following detailed description considered in connection with the accompanying drawings.

### BRIEF DESCRIPTION OF THE DRAWINGS

FIG. 1 is a cross-sectional diagram of an electronic-ink display device according to an embodiment of this invention.

FIG. 2 is a cross-sectional diagram of an electronic-ink display in FIG. 1.

### DETAILED DESCRIPTION

Accordingly, an electronic-ink display device is provided. A cover plate covers the display surface of the electronic-ink display device. Therefore, the electronic-ink display device can get a better protection to resist an impact by an external force.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

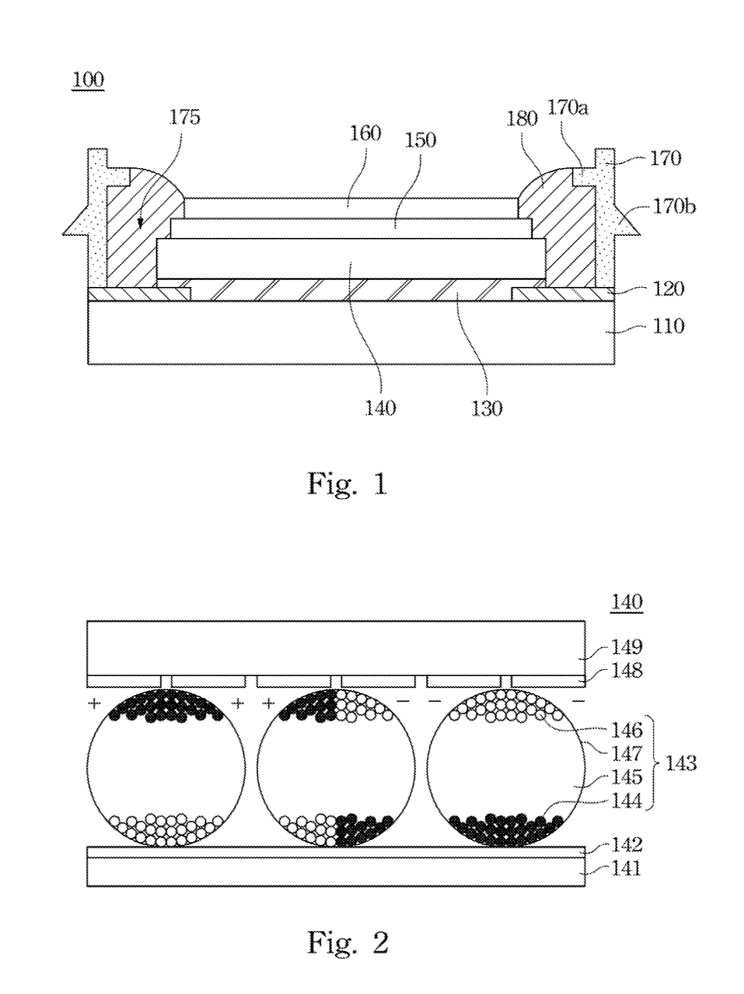

FIG. 1 is a cross-sectional diagram of an electronic-ink display device according to an embodiment of this invention. In FIG. 1, an electronic-ink display device 100 includes a cover plate 110, a printed frame 120, a transparent glue layer 130, an electronic-ink display 140, a first protection layer 150, a second protection layer 160, a frame 170 and a water-proof glue 180.

The electronic-ink display 140 is positioned on the cover plate 110. The printed frame 120 is located on a peripheral area of the cover plate 110, and disposed between the electronic-ink display 140 and the cover plate 110, to define a central display area as a display window. The transparent glue 130 is disposed between the electronic-ink display 140 and the cover plate 110 to adhere the electronic-ink display 140 to the cover plate 110.

The frame 170 is disposed on the peripheral area of the cover plate 110, and surrounds the electronic-ink display 140 to form a circular trench 175 between the electronic-ink display 140 and the cover plate 110 and the frame 170. The water-proof glue 180 fills the circular trench 175. Moreover, the first protection layer 150 is disposed on the electronic-ink display 140 to make the water-proof glue 180 fill between the first protection layer 150 and the frame 170. In this embodiment, the first protection layer 150 can prevent moisture from invading the electronic-ink display 140 from the backside and thus damage the electronic-ink display 140.

When the thickness of the first protection layer 150 is too thin (about 0.2 mm) to block off the waterproof glue 180, the waterproof glue 180 may overflow from the circular trench 175. Then, a second protection layer 160 (about 0.2-0.4 mm thick) can be optionally attached on the first protection layer 150 to keep the waterproof glue 180 stay between the second protection layer 160 and the frame 170. When the thickness of the first protection layer 150 is thick enough (about 0.4 mm) to block off the waterproof glue 180, the second protection layer 160 is not needed. Furthermore, since the function of the second protection layer 160 is prevention of the overflow of the waterproof glue 180, the structure of the second protection layer 160 can be a circular structure positioned on the peripheral area of the first protection layer 150.

For more easily injecting the waterproof glue 180 and increasing the length of the moisture infiltration path, the lateral shape of the stack formed by stacking the electronic-ink display 140, the first protection layer 150, and the second protection layer 160 is a ladder shape to increase the width of the injection port. That is, the area of the electronic-ink display 140 is larger, the area of the second protection layer 160 is smaller, and the area of the first protection layer 150 is between the electronic-ink display 140 and the second protection layer 160. However, if the injection port of the waterproof glue 180 is large enough, such as the width of the injection port is larger than 2 mm, the area of the second protection layer 160 doesn't need to be smaller than the area of the first protection layer 150. The area of the second protection layer 160 can be larger than the area of the first protection layer 150. This invention is not limited thereto.

The cover plate 110 can be planar or curved. The shape of the cover plate 110 is determined by the requirement of the final product. The material of the cover plate 110 can be glass, quartz, or a plastic material with greater hardness, for example. The plastic material above can be polymethylmethacrylate (PMMA), for example.

The material of the transparent glue 130 can be optically clear adhesive (OCA) or transparent water glue to facilitate displaying clear picture by the electronic-ink display device 100.

The detailed structure of the electronic-ink display 140 is shown in FIG. 2, and FIG. 2 is a cross-sectional diagram of an electronic-ink display in FIG. 1. In FIG. 2, the electronic-ink display 140 sequentially includes, from bottom to top, a first transparent substrate 141, a common electrode layer 142, a second transparent glue layer (not shown in FIG. 2), an electronic ink layer 143, a second transparent glue layer (not shown in FIG. 2), a thin film transistor array layer 148, and a second transparent substrate 149. In other embodiments, the first transparent substrate 141 can be omitted. That is, the common electrode layer 142 can be directly disposed on the cover plate 110 to make the final electronic-ink display device 100 to be lighter and thinner.

The electronic ink layer 143 can be composed of microcapsules 147 having negative-charged pigment 144, transparent liquid 145, and positive-charged pigment 146. The electronic ink layer 143 also can be other available electronic ink display technologies. In FIG. 2, since each pixel of the thin film transistor array layer 148 has several electrodes, the distribution of the negative-charged pigment 144 and the positive-charged pigment 146 can be adjusted by the area percentage occupied by the positive and negative electrodes to achieve the goal of displaying various pictures.

The material of the first protection layer 150 and the second protection layer 160 can be polyethylene terephthalate (PET), polyethylene naphthalate (PEN), polycarbonate (PC), PMMA, or glass, for example.

According to another embodiment, the frame 170 can further has at least a first positioning part 170a extending above the circular trench 175 for controlling the height of the filling water-proof glue 180. The first positioning part 170a can be a protrusion part (as shown in FIG. 1) or a recession part. Therefore, the height of the upper surface of the water-proof glue 180 is about the same as the height of the first positioning part 170a.

According to yet another embodiment, the frame 170 can further has at least a second positioning part 170b extending toward an outside direction of the frame 170. The second positioning part 170b is used to assemble a peripheral component to form a final product. The peripheral component can be an outer frame for the final product, for example.

In light of the foregoing, since the display surface of the electronic-ink display device is covered by a lighter cover plate, a layer of glass can be omitted to decrease the weight and the thickness. Therefore, the provided electronic-ink display device above is lighter and thinner. At the same time, the electronic-ink display device can obtain a better protection from the cover plate to resist a greater external impact. Moreover, since the shape of the cover plate can be planar or curved, the design of the final electronic-ink display device can be varied to fulfill the requirements of various products.

All the features disclosed in this specification (including any accompanying claims, abstract, and drawings) may be replaced by alternative features serving the same, equivalent or similar purpose, unless expressly stated otherwise. Thus, each feature disclosed is one example only of a generic series of equivalent or similar features.

What is claimed is:

1. An electronic-ink display device, comprising:
a cover plate;
an electronic-ink display disposed on the cover plate;
a frame disposed on a peripheral area of the cover plate and surrounding the electronic-ink display to form a circular trench; and
a water-proof glue filling the circular trench.

2. The electronic-ink display device of claim 1, wherein the frame has at least a first positioning part extending toward the circular trench for controlling a height of the filling water-proof glue in the circular trench.

3. The electronic-ink display device of claim 1, wherein the frame has at least a second positioning part extending toward an outside direction of the frame for assembling a peripheral component.

4. The electronic-ink display device of claim 1, wherein the cover plate has a curvature.

5. The electronic-ink display device of claim 1, wherein a material of the cover plate is glass, quartz, or plastic.

6. The electronic-ink display device of claim 1, further comprising a transparent glue disposed between the cover plate and the electronic-ink display.

7. The electronic-ink display device of claim 1, further comprising a first protection layer disposed on the electronic-ink display, wherein the water-proof glue fills between the first protection layer and the frame.

8. The electronic-ink display device of claim 7, further comprising a second protection layer disposed on the first protection layer, wherein the water-proof glue fills between the second protection layer and the frame.

9. The electronic-ink display device of aim 1, wherein the electronic-ink display comprises:
a first transparent substrate disposed on the cover plate;
a common electrode layer disposed on the first transparent substrate;
an electronic ink layer disposed on the common electrode layer;
a thin film transistor array layer disposed on the electronic ink layer; and
a second substrate disposed on the thin film transistor array layer.

10. The electronic-ink display device of claim 9, wherein the second substrate is a transparent substrate.

11. The electronic-ink display device of claim 1, wherein the electronic-ink display comprises:
a common electrode layer disposed on the cover plate;
an electronic ink layer disposed on the common electrode layer;
a thin film transistor array layer disposed on the electronic ink layer; and
a second substrate disposed on the thin film transistor array layer.

12. The electronic-ink display device of claim 11, wherein the second substrate is a transparent substrate.
